(19) United States
(12) Patent Application Publication
(10) Pub. No.: US 2023/0244924 A1
(43) Pub. Date: Aug. 3, 2023

(54) SYSTEM AND METHOD FOR ROBUST PSEUDO-LABEL GENERATION FOR SEMI-SUPERVISED OBJECT DETECTION

(71) Applicant: Robert Bosch GmbH, Stuttgart (DE)

(72) Inventors: SHU HU, Buffalo, NY (US); CHUN-HAO LIU, Fremont, CA (US); JAYANTA KUMAR DUTTA, San Jose, CA (US); NAVEEN RAMAKRISHNAN, Campbell, CA (US)

(21) Appl. No.: 17/589,379

(22) Filed: Jan. 31, 2022

(51) Int. Cl. G06N 3/08

(52) U.S. Cl. CPC G06N 3/08

(57) ABSTRACT

A system and method for generating a robust pseudo-label dataset where a labeled source dataset (e.g., video) may be received and used to train a teacher neural network. A pseudo-labeled dataset may then be output from the teacher network and provided to a similarity-aware weighted box fusion (SWBF) algorithm along with an unlabeled dataset. A robust pseudo-label dataset may then be generated by the SWBF algorithm from and used to train a student neural network. The student neural network may also be further tuned using the labeled source dataset. Lastly, the teacher neural network may be replaced using the student neural network. It is contemplated the system and method may be iteratively repeated.

### TECHNICAL FIELD

The present disclosure relates to a system and method for combining unlabeled video data with labeled image data to create robust object detectors to reduce false detections and missed detections and to assist in reducing the need for annotation.

### BACKGROUND

It is also contemplated that deep neural networks (DNNs) with semi-supervised learning (SSL) may be operable to improve object detection problems. Notwithstanding, pseudo-labels generated by the conventional SSL-based object detection models from the unlabeled data may not always be reliable and therefore they cannot always be directly applied to the detector training procedure to improve its. For instance, miss detection and false detection problems can appear in the pseudo-labels, due to the performance bottleneck of the selected object detector. Furthermore, motion information residing in the unlabeled sequence data may be needed to help improve the quality of pseudo-label generation.

### SUMMARY

A system and method for generating a robust pseudo-label dataset is disclosed. The system and method may train a teacher neural network using a received labeled source dataset. A pseudo-labeled dataset may be generated as an output from the teacher neural network. The pseudo-labeled dataset and an unlabeled dataset may be provided to a similarity-aware weighted box fusion algorithm. The robust pseudo-label dataset may be generated from a similarity-aware weighted box fusion algorithm which operates using the pseudo-labeled dataset and the unlabeled dataset. A student neural network may be trained using the robust pseudo-label dataset. Also, the teacher neural network may be replaced with the student neural network.

The system and method may also tune the student neural network using the labeled source dataset. The labeled source dataset may include at least one image and at least one human annotation. The human annotation may comprise a bounding box defining a confidence score for an object within the at least one image. The teacher neural network may also be configured to predict a motion vector for a pixel within a frame of the labeled source dataset. And, the teacher neural network may be trained using a loss function for object detection.

It is also contemplated that the loss function comprises a classification loss and a regression loss for a prediction of the confidence score within the bounding box. The teacher neural network may be re-trained using a prediction function. The similarity-aware weighted box fusion algorithm may further be configured as a motion prediction algorithm operable to enhance a quality of the robust pseudo-label dataset to a first predefined threshold. The similarity-aware weighted box fusion algorithm may further be configured as a noise-resistant pseudo-labels fusion algorithm operable to enhance the quality of the robust pseudo-label dataset to a second predefined threshold.

The system and method may also predict a motion vector for a pixel within a plurality of frames within the unlabeled dataset using an SDC-Net algorithm. Also, the SDC-Net algorithm may be trained using the plurality of frames, wherein the SDC-Net algorithm is trained without a manual label. It is contemplated the similarity-aware weighted box fusion algorithm may comprise a similarity algorithm operable to reduce a confidence score for an object that is incorrectly detected within the pseudo-labeled dataset. The similarity algorithm may also include a class score, a position score, and the confidence score for a bounding box within at least one frame of the pseudo-labeled dataset. The similarity algorithm may further employ a feature-based strategy that provides a predetermined score when the object is determined to be within a defined class. The similarity-aware weighted box fusion algorithm may also be operable to reduce the bounding box which is determined as being redundant and to reduce the confidence score for a false positive result. Lastly, the similarity-aware weighted box fusion algorithm may be operable to average a localization value and the confidence score for a prior frame, a current frame, and a future frame for the object detected within the pseudo-labeled dataset.

### BRIEF DESCRIPTION OF THE DRAWINGS

FIG. 1 depicts an exemplary computing system that may be used by disclosed embodiments.

FIG. 2 is an exemplary block diagram illustrating the methodology for robust pseudo-label generation in semi-supervised object detection.

FIG. 3 is an exemplary block diagram of the similarity-aware weighted boxes fusion algorithm.

FIG. 4 illustrates a computing system controlling an at least partially autonomous robot.

FIG. 5 is an embodiment in which a computer system may be used to control an automated personal assistant.

FIG. 6A is an example of the type-A false positive bidirectional pseudo-label propagation methodology.

FIG. 6B is an example of the type-B false positive from the bidirectional pseudo-label propagation methodology.

FIG. 7 is exemplary pseudo-code for the bidirectional pseudo-label propagation methodology.

FIG. 8 is an example of the bidirectional pseudo-label propagation methodology.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

It is contemplated object detection in images has increased in importance for computer vision tasks in several domains including, for example, autonomous driving, video surveillance, and smart home applications. It may be understood an object detector functions to detect specific objects in images and may also draw a bounding box around the object, i.e. localize the object. Deep neural networks have been shown to be one framework operable to produce reliable object detection. However, it is understood deep neural networks may generally require an extensive amount of labeled training data. To assist the labeling process, one approach may include combining unlabeled images with labeled images to improve object detection performance thereby reducing the need for annotations. But for some applications (e.g. autonomous driving which collects video data) there may be additional information in the form of motion of objects which could be further leveraged to improve object detection performance and further reduce labeling needs. It is therefore contemplated that a system and method may be used to combine unlabeled video data with labeled image to create robust object detectors that not only reduce false detections and missed detections but also help further reduce annotation efforts.

For instance, pseudo-labels may be used to improve object detection. However, the motion information within unlabeled video datasets may typically be overlooked. It is contemplated one method may extend static image-based, semi-supervised methods for use within object detection. Such a method may, however, result in numerous missed and false detections in the generated pseudo-labels. The present disclosure contemplates a different model (i.e., PseudoProp) may be used to generate robust pseudo-labels to improve video object detection in a semi-supervised fashion. It is contemplated the PseudoProp systems and methods may include both a novel bidirectional pseudo-label propagation and an image-semantic-based fusion technique. The bidirectional pseudo-label propagation may be used to compensate for miss detection by leveraging motion prediction. Whereas the image-semantic-based fusion technique may then be used to suppress inference noise by combining pseudo-labels.

It is also contemplated that deep neural networks (DNNs) with semi-supervised learning (SSL) have also improved both image object detection problems. Notwithstanding, pseudo-labels generated by the conventional SSL-based object detection models from the unlabeled data may not always be reliable and therefore they cannot always be directly applied to the detector training procedure to improve its. For instance, miss detection and false detection problems can appear in the pseudo-labels, due to the performance bottleneck of the selected object detector. Furthermore, motion information residing in the unlabeled sequence data may be needed to help improve the quality of pseudo-label generation. However, such data may be overlooked when designing an SSL-based object detector for real-time detection scenarios—like autonomous driving or video surveillance systems. The present disclosure therefore contemplates systems and methods for generating robust pseudo labels to improve the SSL-based object detector performance.

The contemplated systems and methods may be required because existing SSL-based object detection works generally focus on the static image case where the relationship between images may not have been thoroughly considered. It is also understood object detection may leverage SSL-based methods to generate pseudo-labels because the original labeled data may be composed of sparse video frames. In such instances, each frame may be viewed from videos as a static image and static image-based SSL models may then be applied for the object detection. However, motion information between frames may be overlooked in such detection models. The overlooked information can then be exploited to solve miss and false detection problems when predicting pseudo-labels of unlabeled data. While the focus of object tracking is to detect-then-identify similar or the same objects, the present system and methods may focus on improving the object detection task without the need for object reidentification.

Again, this may be done by formulating a first framework for robust pseudo-label generation in SSL-based object detection. As indicated above, the disclosed framework may be referred to as “PseudoProp” due to its operability to exploit motion to propagate pseudo labels. The disclosed PseudoProp framework may include a similarity-aware weighted boxes fusion (SWBF) method based on a novel bidirectional pseudo-label propagation (BPLP). It is contemplated the framework may be operable to solve the miss detection problem and to also reduce the confidence scores for the falsely detected objects.

For instance, to solve miss detection on a specific frame it is contemplated forward and backward motion prediction on the pseudo-labels may be employed for previous and future frames. These pseudo-labels may then be applied (i.e., transferred) into another specific frame. However, the BPLP method will generate many redundant bounding boxes. Furthermore, it will inevitably introduce extra false positives. First, when an object is totally occluded at the current frame, the nonoccluded pseudo-labels will be propagated into the current frame from previous and future frames. In addition, if a false detection already exists in a frame, it will be transferred to other frames in the video sequence. Such false positives can hurt the quality of the generated pseudo-labels.

Thus, the key challenges by applying the BPLP method are to reduce the confidence scores for the false positives and to remove the redundant bounding boxes. It is contemplated one approach may include reducing confidence scores of falsely transferred bounding boxes, based on the similarity between their extracted features. Or another approach may be to adapt the weighted boxes fusion (WBF) algorithm designed for bounding boxes reduction. It is contemplated this alternative approach may reduce the confidence scores of the false positives that exist in the original frames.

Again, the present disclosure therefore contemplates a framework (i.e., PseudoProp) that may be implemented for robust pseudo-label generation in the SSL-based object detection using motion propagation. In addition, the proposed SWBF system and method may be based on a novel BPLP approach operable to solve the miss detection problem and significantly reduce the confidence scores of the false positives in the generated pseudo-labels.

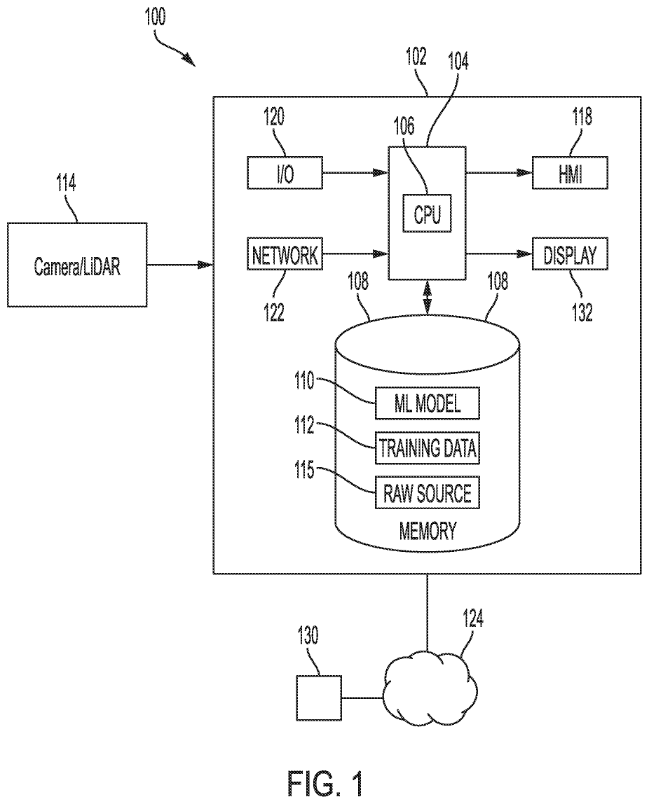

FIG. 1 depicts an exemplary system 100 that may be used to implement the proposed framework. The system 100 may include at least one computing devices 102. The computing system 102 may include at least one processor 104 that is operatively connected to a memory unit 108. The processor 104 may be one or more integrated circuits that implement the functionality of a central processing unit (CPU) 106. It should be understood that CPU 106 may also be one or more integrated circuits that implement the functionality of a general processing unit or a specialized processing unit (e.g., graphical processing unit, ASIC, FPGA, or neural processing unit (NPU)).

The CPU 106 may be a commercially available processing unit that implements an instruction stet such as one of the x86, ARM, Power, or MIPS instruction set families. During operation, the CPU 106 may execute stored program instructions that are retrieved from the memory unit 108. The stored program instructions may include software that controls operation of the CPU 106 to perform the operation described herein. In some examples, the processor 104 may be a system on a chip (SoC) that integrates functionality of the CPU 106, the memory unit 108, a network interface, and input/output interfaces into a single integrated device. The computing system 102 may implement an operating system for managing various aspects of the operation.

The memory unit 108 may include volatile memory and non-volatile memory for storing instructions and data. The non-volatile memory may include solid-state memories, such as NAND flash memory, magnetic and optical storage media, or any other suitable data storage device that retains data when the computing system 102 is deactivated or loses electrical power. The volatile memory may include static and dynamic random-access memory (RAM) that stores program instructions and data. For example, the memory unit 108 may store a machine-learning model 110 or algorithm, training dataset 112 for the machine-learning model 110, and/or raw source data 115.

The computing system 102 may include a network interface device 122 that is configured to provide communication with external systems and devices. For example, the network interface device 122 may include a wired and/or wireless Ethernet interface as defined by Institute of Electrical and Electronics Engineers (IEEE) 802.11 family of standards. The network interface device 122 may include a cellular communication interface for communicating with a cellular network (e.g., 3G, 4G, 5G). The network interface device 122 may be further configured to provide a communication interface to an external network 124 or cloud.

The external network 124 may be referred to as the world-wide web or the Internet. The external network 124 may establish a standard communication protocol between computing devices. The external network 124 may allow information and data to be easily exchanged between computing devices and networks. One or more servers 130 may be in communication with the external network 124.

The computing system 102 may include an input/output (I/O) interface 120 that may be configured to provide digital and/or analog inputs and outputs. The I/O interface 120 may include additional serial interfaces for communicating with external devices (e.g., Universal Serial Bus (USB) interface).

The computing system 102 may include a human-machine interface (HMI) device 118 that may include any device that enables the system 100 to receive control input. Examples of input devices may include human interface inputs such as keyboards, mice, touchscreens, voice input devices, and other similar devices. The computing system 102 may include a display device 132. The computing system 102 may include hardware and software for outputting graphics and text information to the display device 132. The display device 132 may include an electronic display screen, projector, printer or other suitable device for displaying information to a user or operator. The computing system 102 may be further configured to allow interaction with remote HMI and remote display devices via the network interface device 122.

The system 100 may be implemented using one or multiple computing systems. While the example depicts a single computing system 102 that implements all the described features, it is intended that various features and functions may be separated and implemented by multiple computing units in communication with one another. The system architecture selected may depend on a variety of factors.

The system 100 may implement a machine-learning algorithm 110 that is configured to analyze the raw source data 115. The raw source data 115 may include raw or unprocessed sensor data that may be representative of an input dataset for a machine-learning system. The raw source data 115 may include video, video segments, images, and raw or partially processed sensor data (e.g., image data received from camera 114 that may comprise a digital camera or LiDAR). In some examples, the machine-learning algorithm 110 may be a neural network algorithm that is designed to perform a predetermined function. For example, the neural network algorithm may be configured in automotive applications to identify objects (e.g., pedestrians) from images provided from a digital camera and/or depth map from a LiDAR sensor.

The system 100 may store a training dataset 112 for the machine-learning algorithm 110. The training dataset 112 may represent a set of previously constructed data for training the machine-learning algorithm 110. The training dataset 112 may be used by the machine-learning algorithm 110 to learn weighting factors associated with a neural network algorithm. The training dataset 112 may include a set of source data that has corresponding outcomes or results that the machine-learning algorithm 110 tries to duplicate via the learning process. In one example, the training dataset 112 may include source images and depth maps from various scenarios in which objects (e.g., pedestrians) may be identified.

The machine-learning algorithm 110 may be operated in a learning mode using the training dataset 112 as input. The machine-learning algorithm 110 may be executed over a number of iterations using the data from the training dataset 112. With each iteration, the machine-learning algorithm 110 may update internal weighting factors based on the achieved results. For example, the machine-learning algorithm 110 can compare output results with those included in the training dataset 112. Since the training dataset 112 includes the expected results, the machine-learning algorithm 110 can determine when performance is acceptable. After the machine-learning algorithm 110 achieves a predetermined performance level, the machine-learning algorithm 110 may be executed using data that is not in the training dataset 112. The trained machine-learning algorithm 110 may be applied to new datasets to generate annotated data.

The machine-learning algorithm 110 may also be configured to identify a feature in the raw source data 115. The raw source data 115 may include a plurality of instances or input dataset for which annotation results are desired. For example, the machine-learning algorithm 110 may be configured to identify the presence of a pedestrian in images and annotate the occurrences. The machine-learning algorithm 110 may be programmed to process the raw source data 115 to identify the presence of the features. The machine-learning algorithm 110 may be configured to identify a feature in the raw source data 115 as a predetermined feature. The raw source data 115 may be derived from a variety of sources. For example, the raw source data 115 may be actual input data collected by a machine-learning system. The raw source data 115 may be machine generated for testing the system. As an example, the raw source data 115 may include raw digital images from a camera.

In the example, the machine-learning algorithm 110 may process raw source data 115 and generate an output. A machine-learning algorithm 110 may generate a confidence level or factor for each output generated. For example, a confidence value that exceeds a predetermined high-confidence threshold may indicate that the machine-learning algorithm 110 is confident that the identified feature corresponds to the particular feature. A confidence value that is less than a low-confidence threshold may indicate that the machine-learning algorithm 110 has some uncertainty that the particular feature is present.

System 100 is also exemplary of a computing environment that may be used for object detection with regards to the present disclosure. For instance, system 100 may be used for object detection applications such as autonomous driving to detect humans, vehicles, and other objects for safety purposes. Or system 100 may be used for video surveillance system (e.g., cameras 114) to detect indoor objects in real-time. It is also contemplated system 100 may employ a deep learning algorithm for detecting and recognizing objects (e.g., images acquired from camera 114). A deep learning algorithm may be preferable due to its ability to analysis data features and model generalization capabilities.

System 100 may also be configured to implement a semi-supervised learning algorithm (SSL) for vision applications that include object detection and semantic segmentation. With regards to object detection, the SSL algorithm may include pseudo-labels (i.e., bounding boxes) for unlabeled data that may be repeatedly generated using a pre-trained model. It is contemplated the model may be updated by training on a mix of pseudo-labeled and human-annotated data. It is also contemplated the SSL-based object methods may be applied to static images. Lastly, the present disclosure contemplates object detection for videos that leverages SSL-based algorithms to generate pseudo-labels on unlabeled data by considering the relationship among frames within the same video. The disclosed system and method therefore generates pseudo-labels having less false positives and false negatives.

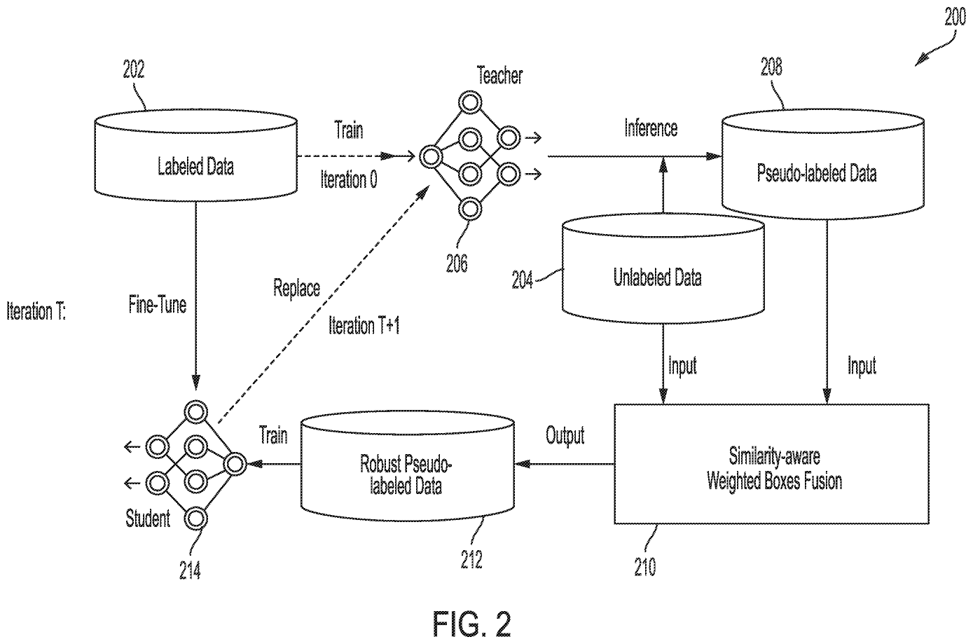

Referring to FIG. 2, an exemplary block diagram 200 of the disclosed framework (i.e., PseudoProp) is illustrated. The framework illustrated by block diagram 200 may be implemented using computing system 102. It is contemplated the block diagram 200 may also be illustrative of a teacher-student framework that may be based on a semi-supervised learning algorithm. It is contemplated the teacher-student framework may further be a knowledge distillation algorithm applied using SSL. While a teacher-student framework may be used for object detection, it is also contemplated the disclosed system and method may also generate robust pseudo-labels based on motion propagation.

At Block 202 a labeled training dataset may be used by system 100 to begin the training portion of the teacher network. It is contemplated the labeled dataset may be a machine learning model 110 stored in memory 108 or may be received by system 100 via external network 124. The labeled training data set may also be illustrated using Equation (1) below:

D_{L}={(\tilde{X}ₗ, \tilde{Y}ₗ)}ᵢ₌₁ⁿ (1)

Where n may be the number of the labeled data; \tilde{X}ₗ may be a frame in a video; and Yₗ may be the corresponding human annotations (i.e., a set of bounding boxes) of \tilde{X}ₗ. It is contemplated the video may be a machine learning model 110 stored in memory 108. Alternatively, the video may be received external network 124 or received in real-time from camera/LiDAR 114.

Block 204 illustrates an unlabeled dataset which may be stored in memory 108 or received by system—e.g., via external network 124. Equation (2) below may also be representative of the unlabeled dataset D_{U} illustrated by block 204:

D_{U}={(\tilde{X}ₗ)}ᵢ₌₁^{m} (2)

where m may be the number of the unlabeled data. It is also contemplated the unlabeled dataset D_{U} may be extracted from multiple video sequences where no manual annotations are provided. Stated differently, the unlabeled dataset may be video sequences that are part of the machine learning model 110 stored in memory 108. Alternatively, the video sequences may be received external network 124 or received in real-time from camera/LiDAR 114.

The human-annotated dataset D_{L} may also be exploited to train the teacher network 206 (which may be represented as θ₁) using a conventional loss function ( [symbol] ) for object detection, where [symbol] may be composed by the classification loss and regression loss for bounding box prediction. It is contemplated Equation (3) below may illustrate the optimal teacher network 206 that may be obtained during the training process.

$${θ}_{1}^{*} = {arg}_{{θ}_{1}} min \frac{1}{n} {\sum }_{( \tilde{{X}_{ι}} , \tilde{{Y}_{ι}} ) ∈ {D}_{L}} ℒ ( \tilde{{Y}_{ι}} , {f}_{{θ}_{1}} ( {X}_{i} ) ) \qquad Equation ( 3 )$$

where θ*₁ may be the optimal teacher network 204 (with a prediction function f) that is obtained during each iteration of the training. As illustrated by FIG. 2, the first iteration may be “iteration 0.” However, it is contemplated the teacher-student network may be an iterative process. The output of the optimal teacher network 204 (i.e., θ*₁) may then be used to generate (or update) Block 208 which may be the pseudo-label dataset for all unlabeled data (D_{U}) within block 202.

Block 210 may be a similarity-aware weighted boxes fusion (SWBF) algorithm designed to receive the unlabeled dataset from block 204 and the pseudo-labeled dataset from block 208. It is contemplated the SWBF algorithm may be a motion prediction model and/or a noise-resistant pseudo-labels fusion model which are operable to enhance the quality of the robust pseudo-label dataset which is generated or output to Block 212. While additional details regarding the SWBF algorithm of Block 210 are provided below Equation (4) illustrates the procedures for generating the high-quality pseudo-labels using the SWBF algorithm.

Yᵢ=f_{θ*}_{₁}(Xᵢ), Y̅ᵢ=SWBF(Yᵢ), ∀Xᵢ∈D_{U} (4)

Where Yᵢ may be a set of pseudo-labels (bounding boxes) of the unlabeled data Xᵢ from the teacher model (Block 206), and Y̅ᵢ may be a set of high-quality pseudo-labels after using the SWBF method on Yᵢ. The pseudo-labeled dataset may then be used to train a student network 214 using the loss function ( [symbol] ) as shown by Equation (5) below:

$${θ}_{2}^{*} = {arg}_{{θ}_{2}} min \frac{1}{m} {\sum }_{\tilde{{X}_{ι}} ∈ {D}_{U}} ℒ ( \overline{{Y}_{i}} , {f}_{{θ}_{2}} ( {X}_{i} ) ) \qquad Equation ( 5 )$$

It is contemplated that since the pseudo-labeled data provided by Block 212 may be noisy, the trained student network 214 may not be operable to achieve a performance level above a predefined threshold. Therefore, the student network 214 may require additional tuning (as shown by “fine-tune” line) using the labeled dataset (D_{L}) before being evaluated on the validation or test dataset as shown below by Equation (6):

$${θ}_{2}^{* *} = {arg}_{{θ}_{2}^{*}} min \frac{1}{m} {\sum }_{( \tilde{{X}_{ι}} , \tilde{{Y}_{ι}} ) ∈ {D}_{L}} ℒ ( \tilde{{Y}_{ι}} , {f}_{{θ}_{2}^{*}} ( {\tilde{X}}_{ι} ) \qquad Equation ( 6 )$$

As is also shown by the dashed line in FIG. 2, the student network 214 (i.e., f_{θ**}_{₂}) may then be used to replace the teacher network 206 (i.e., f_{θ}_{₁}_{⁺}). As stated above, once the teacher network 206 has been replaced by the prior iteration of trained student network 214, the entire process shown by diagram 200 may be repeated.

To estimate motion from unlabeled video frames, the disclosed framework may also adopt an SDC-Net algorithm for predicting the motion vector (du, dv) on each pixel (u, v) per frame Xₜ at time t. It is contemplated the SDC-Net algorithm may be implemented to predict video frame Xₜ₊₁ based on past frame observations as well as estimated optical flows. The SDC-Net algorithm may be designed to outperform traditional optical flow-based motion prediction methods since SDC-Net may be operable to handle a disocclusion problem within given video frames. Furthermore, the SDC-Net algorithm may be trained using consecutive frames without the need to provide manual labels. Lastly, it is contemplated the SDC-Net algorithm may be improved using video frame reconstruction instead of frame prediction (i.e., applying bi-directional frames to reconstruct the current frame). The predicted frame \hat{X}ₜ₊₁ and its corresponding predicted pseudo-labels Ŷₜ₊₁ both of which can be formulated using Equations (7) and (8) shown below:

\hat{X}ₜ₊₁= [symbol] ( [symbol] (X_{t-τ:t+1}, V_{t-τ+1:t+1}), Xₜ) (7)

\hat{Y}ₜ₊₁=T( [symbol] (X_{t-τ:t 1}, V_{t-τ+1:t+1}), Yₜ) (8)

Where X_{t-τ:t} may be the frames from time t−τ+1 to t. It is also considered V_{t-τ+1:t} may be the corresponding optical flows from time t−τ+1 to t. The value [symbol] may be a bilinear sampling operation operable to interpolate the motion-translated frame into the final predicted frame. The value T may be a floor operation for deriving pseudo-labels from motion prediction. Lastly, the value [symbol] may be a convolutional neural network (CNN) (or other networks such as a deep neural network (DNN)) operable to predict the motion vector (du, dv) per pixel on Xₜ. For instance, a non-limiting example of a CNN that may be employed by the teacher network 206 or student network 214 may include one or more convolutional layers; one or more pooling layers; a fully connected layer; and a softmax layer.

As illustrated by FIG. 2, the labeled input dataset 202 may be provided as an input to the teacher network 206 where the robust pseudo-labeled dataset 212 may be provided to the student network. The labeled dataset 202 may be received as a training dataset or from one or more sensors (e.g., camera 114). The dataset may also be lightly processed prior to being provided to CNN. Convolutional layers may be operable to extract features from the datasets provide to the teacher network 206 or student network 214. It is generally understood that convolutional layers 220-240 may be operable to apply filtering operations (e.g., kernels) before passing on the result to another layer of the CNN. For instance, for a given dataset (e.g., color image), the convolution layers may execute filtering routines to perform operations such as image identification, edge detection of an image, and image sharpening.

It is also contemplated that the CNN may include one or more pooling layers that receive the convoluted data from the respective convolution layers. Pooling layers may include one or more pooling layer units that apply a pooling function to one or more convolution layer outputs computed at different bands using a pooling function. For instance, pooling layer may apply a pooling function to the kernel output received from convolutional layer. The pooling function implemented by pooling layers may be an average or a maximum function or any other function that aggregates multiple values into a single value.

A fully connected layer may also be operable to learn non-linear combinations for the high-level features in the output data received from the convolutional layers and pooling layers 250-. Lastly, the CNN implemented by the teacher network 206 or student network 214 may include a softmax layer that combines the outputs of the fully connected layer using softmax functions. It is contemplated that the neural network may be configured for operation within automotive applications to identify objects (e.g., pedestrians) from images provided from a digital camera and/or depth map from a LiDAR sensor.

The disclosed system and method may include a pre-trained optical flow estimation model to generate V, and the video frame reconstruction approach is used for [symbol] . It is contemplated the pre-trained optical flow estimation model may be designed using a FlowNet2 algorithm. The SDC-Net algorithm discussed above may also be pre-trained with unlabeled video sequences in a given dataset (e.g., Cityscapes dataset). The algorithm may select τ=1 and to estimate motion (as opposed to predict future frames) the algorithm may predict future bounding boxes by leveraging the intermediate result from model [symbol] to retrieve the values (du, dv). Also, once all motion vectors on every pixel are gathered, the operator T may be used to predict (u, v) in Yₜ to appear as (u+du, v+dv) in Ŷₜ₊₁ shown in Equation (8) above.

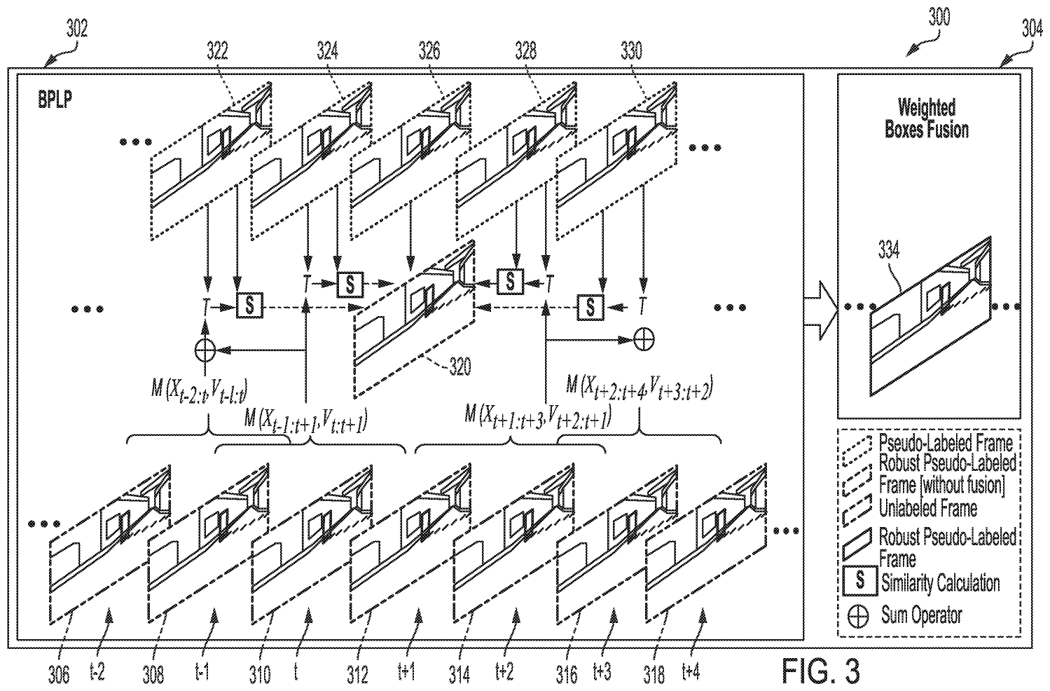

With regards to FIG. 3, an exemplary box diagram 300 of one embodiment for the similarity-aware weighted boxes fusion (SWBF) algorithm which was shown generally as Block 210 in FIG. 1. Block 302 illustrates a bidirectional pseudo-label propagation (BPLP) algorithm operable to generate candidate pseudo-labels according to the motion prediction. Specifically, Block 302 illustrates operation of the BPLP algorithm which is described in greater detail below. As illustrated, a plurality of unlabeled dataset video frames 306-318 may be received (i.e., input) from the unlabeled dataset shown by Block 204. Likewise, a plurality of pseudo-labeled dataset video frames 322-330 may be received from the pseudo-labeled dataset shown by Block 208. The BPLP algorithm may operably perform a summation and similarity calculations using frames 306-318 and frames 322-330 to generate a robust pseudo-labeled frame 320 that has not undergone fusion. Block 304 then illustrates a robust fusion algorithm operable to generate the final pseudo-label dataset that is output to Block 212 in FIG. 1.

Since the predicted (i.e., inferred) pseudo-labels in Block 208 which are generated from the teacher model 206 may contain false negatives, the motion prediction method discussed above with respect to Equations (7) and (8) may be used to propagate the pseudo-label prediction showed in detail as Block 302. However, the motion prediction method using Equations (7) and (8) may only be operable to predict frames and labels in one direction and also one step size. To make the predicted pseudo-labels more robust at time t+1, an interpolation algorithm (i.e., bidirectional pseudo-label propagation) may be operably used to generate pseudo-label proposals. In other words, the original label prediction (forward propagation) and its reversed version (backward propagation) may be used to predict the pseudo-labels. It is also contemplated using the propagation length k∈ [symbol] ⁺ as shown by Equations (9)-(12) below:

$${\overline{Y}}_{t + 1} = {Y}_{t + 1} ⋃ {\hat{Y}}_{t + 1} \qquad Equation ( 9 )$$

$${\hat{Y}}_{t + 1} = {⋃}_{t ∈ K} {\hat{Y}}_{t + 1}^{i} , {\hat{Y}}_{t + 1}^{i} = T ( {\sum }_{j ∈ J} ℳ ( {X}_{t - j : t - j + 2} , {V}_{t + 1 - j : 0} ) , {Y}_{t + 1 - i} \qquad Equation ( 10 )$$

$$s . t . K = \{ \pm 1 , … , \pm ( k - 1 ) , \pm k \} , o = \{ \begin{matrix}t + 2 - j , & if i > 0 \\ t - j , & if i < 0\end{matrix} \qquad Equation ( 11 )$$

$$J = \{ sgn ( i ) \cdot 1 , … , sgn ( i ) \cdot ( \vert i \vert - 1 ) , sgn ( i ) \cdot ( \vert i \vert ) \} \qquad Equation ( 12 )$$

Where

$$sgn ( i ) = \{ \begin{matrix}+ 1 , & if i > 0 \\ - 1 , & if i < 0\end{matrix}$$

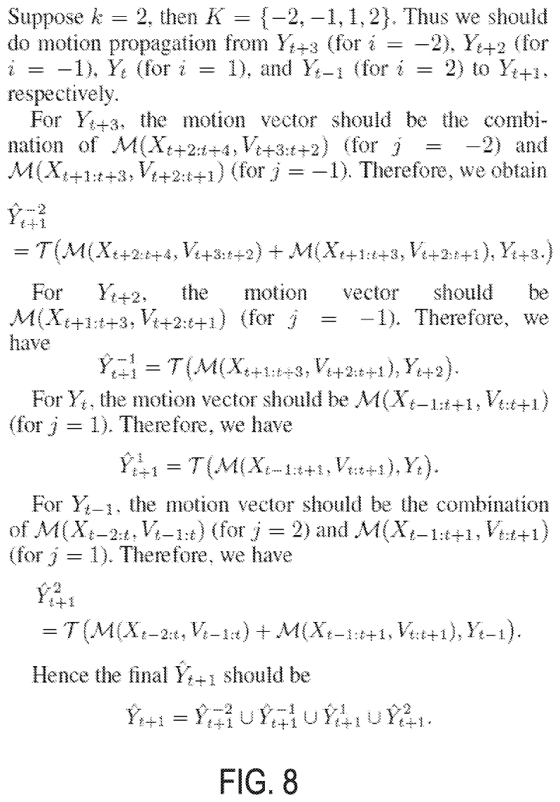

and i∈K. It is contemplated that in the right-hand side of Eq. (9), the first term Yₜ₊₁ may be the pseudo-label set of the unlabeled frame Xₜ₊₁ from the prediction of the teacher model 206. The second term Ŷₜ₊₁ may be a set that contains pseudo-labels from the past and future frames after using the motion propagation which may be derived using Eq. (12) above. The expression Ŷₜ₊₁ⁱ may be the pseudo-label set from Yₜ₊₁₋ᵢ. It is also contemplated the value Y̅ₜ₊₁ may be computed for Xₜ₊₁ by applying a union operation to the Yₜ₊₁ and Ŷₜ₊₁. In the set K, “+” indicates a forward propagation, and “−” represents a backward propagation. FIG. 8 is an example illustrating how Ŷₜ₊₁ may be computed.

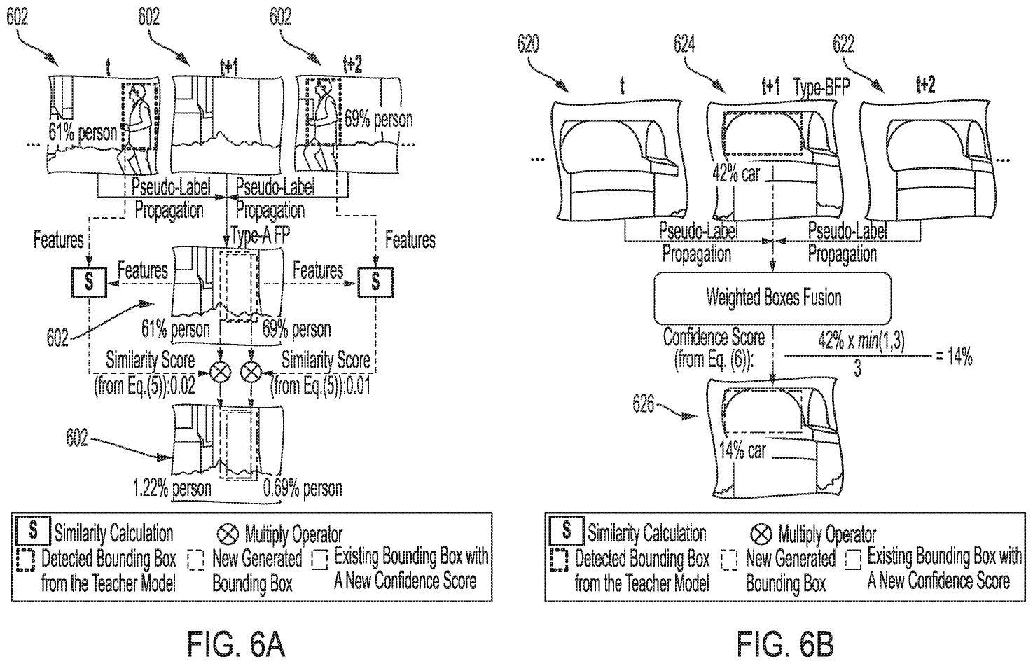

The BPLP algorithm with different k settings can create many candidate pseudo-labels as illustrated by Block 320. However, it is contemplated extra (two types) false positives (FP) may also be introduced. As shown by FIG. 6A a Type-A FP may be introduced where the algorithm is operable to detect a person at time t (Block 602) and t+2 (Block 604) but the person cannot be detected at time t+1 (Block 606). The reason the person may not be detected is because they are occluded by a tree in Block 606. However, through the BPLP method, two bounding boxes will appear at time t+1 as shown by Block 608. Block 610 shows the final bounding boxes with confidence scores of a person being detected within image t+1, but the confidence scores may not be as high as Blocks 402 and 406 because the person has been occluded.

With regards to For the Type-B FP, as shown in FIG. 6B, an object (e.g., billboard shown in Blocks 620 and 622) may mistakenly be detected as a different object (e.g., a car) at time t+1 (Block 624) with a high confidence score. Furthermore, the number of candidate pseudo-labels (bounding boxes) increases as the value of k increases (as shown by Block 626). Therefore, many redundant bounding boxes may appear in Yₜ₋₁ for the target frame Xₜ₊₁.

It is therefore contemplated based on the above observations that to reduce the confidence scores of the FP a similarity calculation approach may be implemented (as shown within Block 302) as shown by Equation (13) below.

Yₜ₊₁₋ᵢ:={(Lₜ₊₁₋ᵢ^{z}, Pₜ₊₁₋ᵢ^{z}, Sₜ₊₁₋ᵢ^{z})}_{z=1}^{|Y}^{_{t+1−i}}^{|} (13)

Where Lₜ₊₁₋ᵢ^{z}, Pₜ₊₁₋ᵢ^{z}, Sₜ₊₁₋ᵢ^{z} may be the class, positions, and confidence scores of the z-th bounding box in Yₜ₊₁₋ᵢ. The value |Yₜ₊₁₋ᵢ| may also represent the number of the bounding boxes in Yₜ₊₁₋ᵢ. Similarly Ŷₜ₊₁ⁱ may be defined as shown in Equation (14) below:

\hat{Y}ₜ₊₁ⁱ:={(\hat{L}ₜ₊₁^{i,z}, \hat{P}ₜ₊₁^{i,z}, Ŝₜ₊₁^{i,z})}_{z=1}^{|Y}^{ₜ₊₁}^{|} (14)

It is also contemplated that Lₜ₊₁₋ᵢ^{z} may equal \hat{L}ₜ₊₁^{i,z}, ∀z because the bounding box class may not be modified during the propagation. The value Pₜ₊₁^{i,z} may be obtained from Pₜ₊₁₋ᵢ^{z} by applying T shown by Equation (10) above. It is also understood Sₜ₊₁₋ᵢ^{z}=Ŝₜ₊₁^{i,z}, ∀z but this may cause the Type-A false positive illustrated by FIG. 6A. It is therefore contemplated a similarity score “sim” based on \hat{P}ₜ₊₁^{i,z} and Pₜ₊₁₋ᵢ^{z} to the bounding box confidence score may be implemented, which may also be transitioned from Sₜ₊₁₋ᵢ^{z} and Ŝₜ₊₁^{i,z}. The present framework may calculate the similarity by cropping images at frame Xₜ₊₁₋ᵢ and Xₜ₊₁ according to the positions Pₜ₊₁₋ᵢ^{z} and \hat{P}ₜ₊₁^{i,z}.

It is then contemplated the pre-trained neural network may be used to extract the high-level feature representatives from the cropped images. Finally, the similarity may be obtained by comparing these two high level feature representatives. A feature-based method may be used for similarity calculation in order to provide the same score to the object if it is with the same class before and after pseudo-label propagation. If not, the calculation may otherwise provide a low score in order to reduce the Type-A FP. The scoring may be determined using Equation (15) below.

Ŝₜ₊₁^{i,z}=Sₜ₊₁₋ᵢ^{z}·sim(C(Pₜ₊₁^{i,z}), C(Pₜ₊₁₋ᵢ^{z})) (16)

where C(·) may be a function that can extract the high-level feature representatives from the cropped images based on the box positions. The above similarity method algorithm may allow reductions in the confidence scores of the Type-A False Positives as shown by FIG. 6A.

Although the similarity calculation may reduce the confidence score for some Type-A FP, it may not be operable for handling the Type-B FP and reducing redundant bounding boxes. Therefore, a WBF algorithm may be implemented to reduce the redundant bounding boxes and further reduce confidence scores for the Type-B FP boxes. The WBF algorithm may be designed to average the localization and confidence scores of predictions from all sources (previous, current frame, and future frames) on the same object.

Prior to using the fusion, Y̅ₜ₊₁ may be split into d parts according to the bounding boxes classes. It is contemplated d may be the total number of classes in Y̅ₜ₊₁. It is also contemplated that Y̅_{t+1,c}⊆Y̅ₜ₊₁ may be defined as a subset for the c-th class. For each subset, i.e. Y̅_{t+1,c}, the following fusion procedures may be included:

First, the bounding boxes may be divided from Y̅_{t+1,c} into different clusters. For each cluster, the intersection over union (IoU) of each two bounding boxes should be greater than a user-defined threshold. It is contemplated the user-defined threshold may be approximately 0.5.

Second, for boxes in each cluster r, an average confidence score Cᵣ may be calculated and the weighted average for the positions using Equations (17) and (18) below.

$${C}_{r} = \frac{1}{B} {\sum }_{l = 1}^{B} {C}_{r}^{l} \qquad Equation ( 17 )$$

$${P}_{r} = \frac{{Σ}_{l = 1}^{B} {C}_{r}^{l} \cdot {P}_{r}^{l}}{{Σ}_{l = 1}^{B} {C}_{r}^{l}} \qquad Equation ( 18 )$$

Where B may be the total number of boxes in the cluster r. Also, Cᵣ^{l} and Pᵣ^{l} may be the confidence score and the position of the l-th box in the cluster r.

Third, the first and second procedures may be used to reduce the redundant bounding boxes. However, it is contemplated these procedures may not be operable to solve the Type-B False Positives shown by FIG. 6B. To reduce the confidence score of false detected boxes, Cr may be rescaled using Equation (19) below.

$${C}_{r} = {C}_{r} \cdot \frac{min ( B , \vert K \vert + 1 )}{\vert K \vert + 1} \qquad Equation ( 19 )$$

Where |K| may be the size of the set K discussed above. If a small number of sources can provide pseudo-labels on an object, detection may most likely be a false detection as illustrated by FIG. 6B.

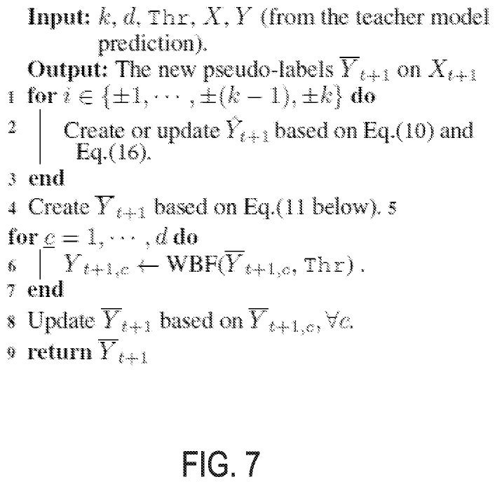

Finally, Y̅_{t+1,c} may only contain the averaged bounding box information (c, Pᵣ, Cᵣ) from each cluster. Therefore, it is contemplated the final Y̅ₜ₊₁ may contain the updated Y̅_{t+1,c} from each class. FIG. 7 illustrates an exemplary version of the pseudo-code for this fusion method.

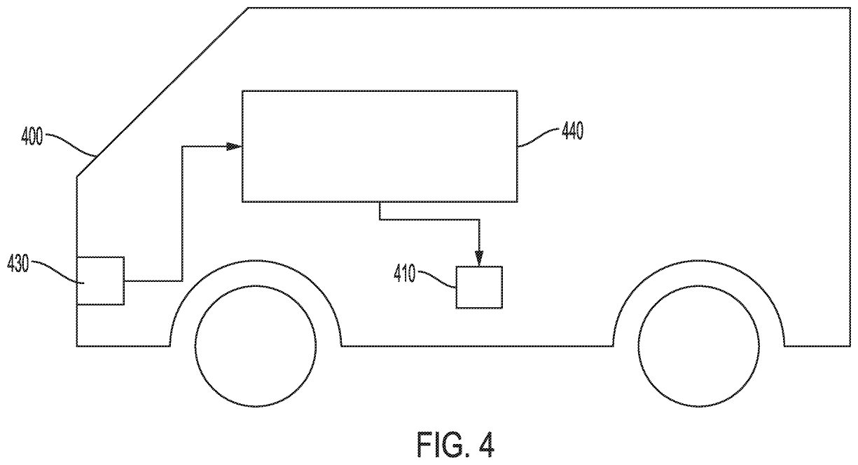

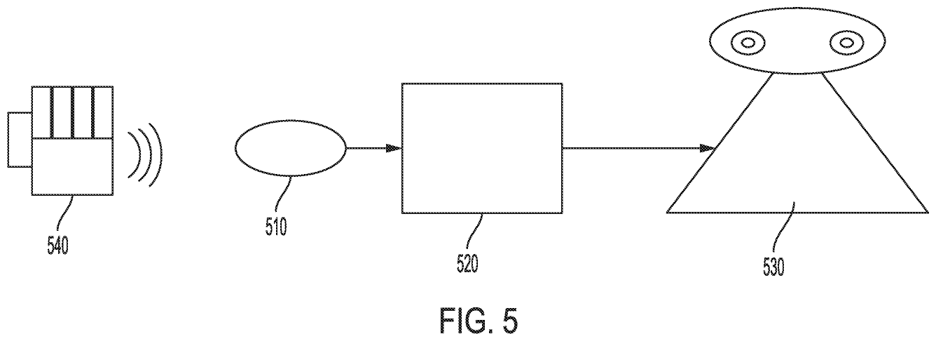

FIGS. 4-5 illustrate various applications that may be used for implementation of the framework disclosed by FIGS. 2 and 3. For instance, FIG. 4 illustrates an embodiment in which a computing system 440 may be used to control an at least partially autonomous robot, e.g. an at least partially autonomous vehicle 400. The computing system 440 may be like the system 100 described in FIG. 1. Sensor 430 may comprise one or more video/camera sensors and/or one or more radar sensors and/or one or more ultrasonic sensors and/or one or more LiDAR sensors and/or one or more position sensors (like e.g. GPS). Some or all these sensors are preferable but not necessarily integrated in vehicle 400.

Alternatively, sensor 430 may comprise an information system for determining a state of the actuator system. The sensor 430 may collect sensor data or other information to be used by the computing system 440. One example for such an information system is a weather information system which determines a present or future state of the weather in environment. For example, using input signal x, the classifier may for example detect objects in the vicinity of the at least partially autonomous robot. Output signal y may comprise an information which characterizes where objects are located in the vicinity of the at least partially autonomous robot. Control command A may then be determined in accordance with this information, for example to avoid collisions with said detected objects.

Actuator 410, which may be integrated in vehicle 400, may be given by a brake, a propulsion system, an engine, a drivetrain, or a steering of vehicle 400. Actuator control commands may be determined such that actuator (or actuators) 410 is/are controlled such that vehicle 400 avoids collisions with said detected objects. Detected objects may also be classified according to what the classifier deems them most likely to be, e.g. pedestrians or trees, and actuator control commands may be determined depending on the classification.

Shown in FIG. 5 is an embodiment in which computer system 540 is used for controlling an automated personal assistant 550. Sensor 530 may be an optic sensor, e.g. for receiving video images of a gestures of user 549. Alternatively, sensor 530 may also be an audio sensor e.g. for receiving a voice command of user 549.

Control system 540 then determines actuator control commands A for controlling the automated personal assistant 550. The actuator control commands A are determined in accordance with sensor signal S of sensor 530. Sensor signal S is transmitted to the control system 540. For example, classifier may be configured to e.g. carry out a gesture recognition algorithm to identify a gesture made by user 549. Control system 540 may then determine an actuator control command A for transmission to the automated personal assistant 550. It then transmits said actuator control command A to the automated personal assistant 550.

For example, actuator control command A may be determined in accordance with the identified user gesture recognized by classifier. It may then comprise information that causes the automated personal assistant 550 to retrieve information from a database and output this retrieved information in a form suitable for reception by user 549.

In further embodiments, it may be envisioned that instead of the automated personal assistant 550, control system 540 controls a domestic appliance (not shown) controlled in accordance with the identified user gesture. The domestic appliance may be a washing machine, a stove, an oven, a microwave or a dishwasher.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for generating a robust pseudo-label dataset, comprising:
receiving a labeled source dataset;
training a teacher neural network using the labeled source dataset;
generating a pseudo-labeled dataset as an output from the teacher neural network;
providing the pseudo-labeled dataset and an unlabeled dataset to a similarity-aware weighted box fusion algorithm;
generating the robust pseudo-label dataset from a similarity-aware weighted box fusion algorithm which operates using the pseudo-labeled dataset and the unlabeled dataset;
training a student neural network using the robust pseudo-label dataset; and
replacing the teacher neural network with the student neural network.

2. The method of claim 1, further comprising: tuning the student neural network using the labeled source dataset.

3. The method of claim 1, wherein the labeled source dataset includes at least one image and at least one human annotation.

4. The method of claim 3, wherein the at least one human annotation comprises a bounding box defining a confidence score for an object within the at least one image.

5. The method of claim 4, wherein the teacher neural network is configured to predict a motion vector for a pixel within a frame of the labeled source dataset.

6. The method of claim 4, wherein the teacher neural network is trained using a loss function for object detection.

7. The method of claim 6, wherein the loss function comprises a classification loss and a regression loss for a prediction of the confidence score within the bounding box.

8. The method of claim 1, further comprising: re-training the teacher neural network using a prediction function.

9. The method of claim 1, wherein the similarity-aware weighted box fusion algorithm is configured as a motion prediction algorithm operable to enhance a quality of the robust pseudo-label dataset to a first predefined threshold.

10. The method of claim 9, wherein the similarity-aware weighted box fusion algorithm is configured as a noise-resistant pseudo-labels fusion algorithm operable to enhance the quality of the robust pseudo-label dataset to a second predefined threshold.

11. The method of claim 1, further comprising: predicting a motion vector for a pixel within a plurality of frames within the unlabeled dataset using an SDC-Net algorithm.

12. The method of claim 11, further comprising: training the SDC-Net algorithm using the plurality of frames, wherein the SDC-Net algorithm is trained without a manual label.

13. The method of claim 12, wherein the similarity-aware weighted box fusion algorithm comprises a similarity algorithm operable to reduce a confidence score for an object that is incorrectly detected within the pseudo-labeled dataset.

14. The method of claim 13, wherein the similarity algorithm includes a class score, a position score, and the confidence score for a bounding box within at least one frame of the pseudo-labeled dataset.

15. The method of claim 14, wherein the similarity algorithm employs a feature-based strategy that provides a predetermined score when the object is determined to be within a defined class.

16. The method of claim 15, wherein the similarity-aware weighted box fusion algorithm is operable to reduce the bounding box which is determined as being redundant and to reduce the confidence score for a false positive result.

17. The method of claim 16, wherein the similarity-aware weighted box fusion algorithm is operable to average a localization value and the confidence score for a prior frame, a current frame, and a future frame for the object detected within the pseudo-labeled dataset.

18. A method for generating a robust pseudo-label dataset, comprising:
receiving a labeled dataset including a plurality of frames;
training a teacher convolutional neural network using the labeled dataset;
generating a pseudo-labeled dataset as an output from the teacher convolutional neural network;
providing the pseudo-labeled dataset and an unlabeled dataset to a similarity-aware weighted box fusion algorithm;
generating the robust pseudo-label dataset from a similarity-aware weighted box fusion algorithm which operates using the pseudo-labeled dataset and the unlabeled dataset;
training a student convolutional neural network using the robust pseudo-label dataset;
and replacing the teacher convolutional neural network with the student convolutional neural network.

19. The method of claim 18, further comprising: tuning the student convolutional neural network using the labeled dataset.

20. A system for generating a robust pseudo-label dataset, comprising:
a processor configured to:
receive a labeled source dataset;
train a teacher neural network using the labeled source dataset;
generate a pseudo-labeled dataset as an output from the teacher neural network;
provide the pseudo-labeled dataset and an unlabeled dataset to a similarity-aware weighted box fusion algorithm;
generate the robust pseudo-label dataset from a similarity-aware weighted box fusion algorithm which operates using the pseudo-labeled dataset and the unlabeled dataset;
train a student neural network using the robust pseudo-label dataset; and
replace the teacher neural network with the student neural network.
